(19) United States
(12) Patent Application Publication
(10) Pub. No.: US 2021/0223638 A1
(43) Pub. Date: Jul. 22, 2021

(54) ARRAY SUBSTRATE AND METHOD OF MANUFACTURING THE SAME, DISPLAY PANEL AND DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Kui Gong, Beijing (CN); Xianxue Duan, Beijing (CN); Dezhi Xu, Beijing (CN)

(21) Appl. No.: 16/098,811

(22) PCT Filed: Jan. 17, 2018
(86) PCT No.: PCT/CN2018/073012

§ 371 Date: Nov. 2, 2018

(30) Foreign Application Priority Data
Jul. 25, 2017 (CN) 201710616503.5

(51) Int. Cl. G02F 1/1343; G02F 1/1335

(52) U.S. Cl. CPC G02F 1/134363; G02F 1/133553; G02F 1/13439

(57) ABSTRACT

An array substrate and a manufacturing method thereof, a display panel and a display device are provided. The array substrate includes a plurality of pixel units, at least some of which respectively having a reflective region provided with a reflective layer in a concave-convex shape, wherein a first insulating layer is disposed on a light reflecting side of the reflective layer, and a surface of the first insulating layer adjacent to the reflective layer is in a concave-convex shape conforming to the concave-convex shape of the reflective layer, and a surface of the first insulating layer away from the reflective layer is a planar surface; the at least some of the pixel units further respectively comprise a first electrode and a second electrode which are oppositely disposed in different layers and are spaced apart from each other, and the first electrode is disposed on a side of the first insulating layer away from the reflective layer.

### CROSS-REFERENCE TO RELATED APPLICATION

The present application is the U.S. national phase of PCT Application No. PCT/CN2018/073012 filed on Jan. 17, 2018, which claims the benefit of Chinese Patent Application No. 201710616503.5 filed on Jul. 25, 2017 in the State Intellectual Property Office of China, the whole disclosure of which is incorporated herein by reference.

### TECHNICAL FIELD

Embodiments of the present disclosure relate to a technical field of display technologies, and in particular, to an array substrate and a method of manufacturing the same, a display panel and a display device.

### BACKGROUND

A liquid crystal display panel of a reflective type or a transflective type has a reflective region in a pixel structure thereof, and a portion of the array substrate corresponding to the reflective region has a reflective layer to reflect external light. In a liquid crystal display panel of the reflective type or the transflective type in the related art, in order to improve reflection efficiency of the reflective region, the reflective layer in the array substrate is configured to be in a concave-convex structure. However, such a structure causes electrodes above the reflective layer to be disposed on a concave-convex surface, so that an electric field formed in the liquid crystal display panel is distorted, thereby causing the liquid crystal molecules to be deflected abnormally, reducing the transmittance of the light emitted out of the reflective region, and resulting in that the reflective region fail to achieve a desired brightness, which adversely affects the display effect of the liquid crystal display panel.

### SUMMARY

One of the purposes of the present disclosure is to provide an array substrate and a method of manufacturing the same, a display panel and a display device.

According to an aspect of the present disclosure, there is provided an array substrate comprising a plurality of pixel units, at least some of which respectively having a reflective region provided with a reflective layer in a concave-convex shape, wherein a first insulating layer is disposed on a light reflecting side of the reflective layer, and a surface of the first insulating layer adjacent to the reflective layer is in a concave-convex shape conforming to the concave-convex shape of the reflective layer, and a surface of the first insulating layer away from the reflective layer is a planar surface; the at least some of the pixel units further respectively comprise a first electrode and a second electrode which are oppositely disposed in different layers and are spaced apart from each other, and the first electrode is disposed on a side of the first insulating layer away from the reflective layer.

According to an embodiment of the present disclosure, the first electrode is a comb electrode and the second electrode is a plate electrode.

According to an embodiment of the present disclosure, the array substrate further comprises a second insulating layer disposed on a side of the reflective layer away from the first insulating layer, the surface of the second insulating layer adjacent to the reflective layer is in a concave-convex shape conforming to the concave-convex shape of the reflective layer.

According to an embodiment of the present disclosure, the second electrode is disposed on a side of the reflective layer away from the first insulating layer.

According to an embodiment of the present disclosure, the second electrode is disposed between the reflective layer and the second insulating layer, and the second electrode is in a concave-convex shape conforming to the concave-convex shape of the reflective layer.

According to an embodiment of the present disclosure, the second electrode is disposed on a side of the second insulating layer away from the reflective layer.

According to an embodiment of the present disclosure, the second electrode is disposed on a side of the reflective layer away from the second insulating layer and is a transparent electrode.

According to an embodiment of the present disclosure, the second electrode is disposed between the reflective layer and the first insulating layer, and the second electrode is in a concave-convex shape conforming to the concave-convex shape of the reflective layer.

According to an embodiment of the present disclosure, the second electrode is disposed between the first electrode and the first insulating layer, a third insulating layer is disposed between the second electrode and the first electrode, and the second electrode extends in a plane parallel to a planar surface of the first insulating layer.

According to an embodiment of the present disclosure, the second electrode is formed integrally with the reflective layer.

According to an embodiment of the present disclosure, one of the first electrode and the second electrode is a pixel electrode, and the other of the first electrode and the second electrode is a common electrode.

According to an embodiment of the present disclosure, the at least some of the pixel units further respectively comprise a transmissive region, the transmissive region not including the reflective layer.

According to an embodiment of the present disclosure, each of the pixel units comprises a reflective region.

According to another aspect of the present disclosure, there is provided a method of manufacturing an array substrate, the array substrate comprising a plurality of pixel units, at least some of which respectively having a reflective region, the method comprising at least: forming a reflective layer in a concave-convex shape in the reflective region; forming a first insulating layer on a light reflecting side of the reflective layer; performing a planarization process a surface of the first insulating layer away from the reflective layer to form a planar surface; and forming a first electrode on a side of the first insulating layer away from the reflective layer, the first electrode extending on the planar surface of the first insulating layer.

According to an embodiment of the present disclosure, the method further comprises forming a second insulating layer before forming the reflective layer; patterning the second insulating layer such that a surface of the second insulating layer adjacent to a subsequently formed reflective layer is in a concave-convex shape; forming the reflective layer on a side of the second insulating layer in a concave-convex shape such that the reflective layer is also in a concave-convex shape.

According to an embodiment of the present disclosure, the planarization process is chemical mechanical polishing.

According to an embodiment of the present disclosure, disposing the second electrode on a side of the reflective layer away from the first insulating layer, or configuring the second electrode as a transparent electrode and disposing the second electrode on a side of the reflective layer away from the second insulating layer.

According to another aspect of the present disclosure, there is provided a display panel comprising: the array substrate mentioned above.

According to another aspect of the present disclosure, there is provided a display device comprising the display panel mentioned above.

According to an embodiment of the present disclosure, a depth of the planarization process to the surface of the first insulating layer away from the reflective layer is less than a thickness of the first insulating layer.

### BRIEF DESCRIPTION OF THE DRAWINGS

FIG. 1 shows a structural schematic view of an array substrate of a liquid crystal display panel of the reflective type according to an exemplary embodiment of the present disclosure;

FIGS. 2A-2C show schematic views of a manufacturing process of the array substrate shown in FIG. 1;

FIG. 3 shows a structural schematic view of the liquid crystal display panel of the reflective type including the array substrate shown in FIG. 1, in which a power line distribution of a substantially normal electric field is shown;

FIG. 4 shows a structural schematic view of an array substrate of a liquid crystal display panel of the reflective type according to another exemplary embodiment of the present disclosure;

FIG. 5 shows a structural schematic view of an array substrate of a liquid crystal display panel of the reflective type according to another exemplary embodiment of the present disclosure;

FIG. 6 shows a structural schematic view of an array substrate of a liquid crystal display panel of the reflective type according to another exemplary embodiment of the present disclosure;

FIG. 7 shows a structural schematic view of a liquid crystal display panel of the reflective type as an alternative example in which a power line distribution of a distorted electric field is shown;

FIG. 8 shows a schematic structural view of an array substrate of a liquid crystal display panel of the transflective type according to an exemplary embodiment of the present disclosure;

FIGS. 9A-9C show schematic views of a manufacturing process of the array substrate shown in FIG. 8; and

FIG. 10 shows a schematic structural view of a liquid crystal display panel of the transflective type including the array substrate shown in FIG. 8, in which a power line distribution of a substantially normal electric field is shown.

### DETAILED DESCRIPTION OF EMBODIMENTS

The embodiments of the present disclosure will be described in detail below with reference to the accompanying drawings. It is to be understood that the following description of the embodiments is intended to be illustrative. In the specification and the drawings, the same or similar reference numerals are used to refer to the same or similar components or members. For the sake of clarity, the drawings are not necessarily drawn to scale, and some of the known components and structures may be omitted in the drawings.

Unless otherwise defined, technical or scientific terms used in the present disclosure shall be of ordinary meaning as understood by those skilled in the art. The words “first” “second” and similar terms used in the present disclosure do not denote any order, quantity, or importance, but are used to distinguish different components. The words “a” or “an” don't exclude a plurality. The words “including” or “comprising” and the like, are intended to mean that the elements or items that appear before such words cover the elements or items and the like which are listed after such words and don't exclude other elements or items. The words “connected” or “coupled” and the like are not limited to physical or mechanical connections, but may include electrical connections, regardless directly or indirectly. “Upper”, “lower”, “left”, “right”, “top” or “bottom” and the like are only used to indicate relative positional relationship. When absolute position of the object to be described is changed, the relative positional relationship may also be changed correspondingly. When an element such as a layer, a film, a region or a substrate is referred to as being “on”, “above” or “below” or “under” another element, the element can be “directly” on or under the other element, or there may be intermediate elements.

In the present disclosure, when referring to formation a “normal” electric field between two electrodes, it means that the electric field is formed in a situation that the two electrodes are in two parallel planes and the layers between the two electrodes are planar layer. Under the action of the “normal” electric field, long axes of the liquid crystal molecules are in a plane parallel to the two electrodes, and such a deflection of the liquid crystal molecules is called “normal” deflection of the liquid crystal molecules, so that the display panel displays pictures “normally”. In contrast, if a “normal” electric field is not formed between the two electrodes, the electric field formed between the two electrodes is referred to as “distorted”, at which time long axes of at least some of the liquid crystal molecules are not parallel to the plane in which the electrodes are located.

In the present disclosure, a “concave-convex shape” refers to a non-planar shape, surface of which has undulations. A surface in a concave-convex shape is referred to as a “concave-convex surface”. In the case where an upper surface and a lower surface of one layer are both concave-convex surfaces, the degree and manner of undulation in the two concave-convex surfaces may be the same, at which time such a layer has a substantially constant thickness. The degree and manner of undulation in a concave-convex surface can vary. The degree of undulation refers to difference in height between a peak and a valley on the concave-convex surface, which may be, for example, 10% to 200% of the thickness of the layer having a concave-convex surface. The concave-convex surface may be concave and convex in one dimension in the surface and be planar in another dimension perpendicular the one dimension, or may be concave and convex in both dimensions. A cutting line of the concave-convex surface which is substantially perpendicular to the surface may be in a zigzag shape or a wavy shape, especially in a triangular function curve shape, or may be, for example, in a periodic conical curve shape, or in a shape or other shape similar to these shapes. In the case where one layer has a concave-convex surface and is in close contact with a surface of another layer by the concave-convex surface, the surface of the another layer generally also has a concave-convex surface conforming to the concave-convex surface of said one layer, or the another layer is in a concavo-convex shape that conforms to the concavo-convex shape of the one layer.

In the present disclosure, a “planar surface” as with respect to a “concave-convex surface” refers to a planar or substantially planar surface. There may be slight undulations in the planar surface, or there may be coarse structures, in which case the height difference between the peaks and valleys of the planar surface is typically less than, for example, 10%, especially less than 5%, of the thickness of the layer having the planar surface.

FIG. 1 shows a structural schematic view of an array substrate 100 of a liquid crystal display panel of the reflective type according to an exemplary embodiment of the present disclosure. As shown in FIG. 1, the array substrate 100 includes, in an order from bottom to top in FIG. 1, a base substrate 101, a second insulating layer 102, a second electrode 103, a reflective layer 104, a first insulating layer 105 and a first electrode 106. One of the first electrode 106 and the second electrode 103 is a pixel electrode, and the other of the first electrode 106 and the second electrode 103 is a common electrode.

The base substrate 101 may be, for example, a planar glass substrate on which a TFT element film layer may be formed for supplying a driving voltage to the first electrode 106 or the second electrode 103. The second insulating layer 102 is disposed on the base substrate 101, and an upper surface 102a of the second insulating layer 102 is in a concavo-convex shape. The second electrode 103 above the second insulating layer 102 is a plate-shaped electrode and has a uniform thickness, and a lower surface of the second electrode 103 is in a concavo-convex shape conforming to the concavo-convex shape of the upper surface of the second insulating layer 102. The reflective layer 104 above the second electrode 103 has a uniform thickness, and the reflective layer 104 is also in a concavo-convex shape that conforms to the concavo-convex shape of the upper surface of the second insulating layer 102. Here, the concavo-convex shape of the reflective layer 104 may be any structure capable of enhancing the reflectance of the reflective layer to light, such as a zigzag shape, a wavy shape, or the like. The first insulating layer 105 is disposed above the reflective layer 104. A lower surface 105b of the first insulating layer 105 is in a concavo-convex shape that conforms to the concavo-convex shape of the reflective layer 104. An upper surface 105a of the first insulating layer 105 is formed as a planar surface. The first electrode 106 is a comb electrode and is formed on the planar surface, i.e., the upper surface 105a of the first insulating layer 105, and the first electrode 106 extends on the planar surface of the first insulating layer 105.

According to this embodiment, the second electrode 103 is disposed on a side of the second insulating layer 102 adjacent to the reflective layer 104, the second electrode 103 is disposed below the reflective layer 104, and the second electrode 103 is disposed to abut against the reflective layer 104. Therefore, the second electrode 103 does not adversely affect the reflectance of the reflective layer 104, and the thickness of the array substrate is relatively small.

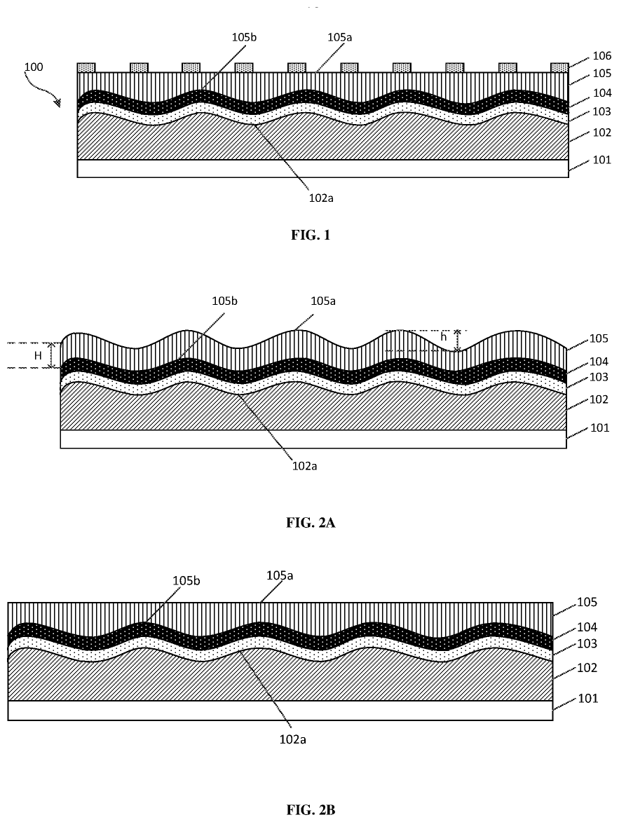

FIGS. 2A-2C show schematic views of a manufacturing process of the array substrate shown in FIG. 1. As shown in FIG. 2A, firstly, a base substrate 101 is provided, which may include a TFT film layer; an insulating layer (second insulating layer) 102, e.g. a photoresist layer, is laid on the base substrate 101. The upper surface 102a of the second insulating layer 102 is formed into a concavo-convex shape by, for example, a molding process. Next, a second electrode layer is deposited on the second insulating layer 102, whose upper surface is in a concavo-convex shape, by for example a sputtering process, and then is patterned to form the second electrode 103. The material of the second electrode may be a metal or an alloy. Next, the reflective layer 104 is deposited on the second electrode 103 by, for example, a sputtering process. The material of the reflective layer 104 may be a metal such as silver that has a function to reflect lights. Next, a transparent insulating layer (i.e. the first insulating layer) 105 is deposited on the reflective layer 104, for example, by a chemical vapor phase process. The first insulating layer is made of a transparent material. The second electrode 103, the reflective layer 104, and the first insulating layer 105 are deposited respectively, each of which has a uniform thickness, such that the upper and lower surfaces of the second electrode 103, the reflective layer 104, and the first insulating layer 105 are also in a concave-convex shape conforming to the shape of the upper surface of the second insulating layer 102. A height h of the concavo-convex shape of the upper surface of the first insulating layer 105 (a vertical height between the highest point and the lowest point of the concave-convex surface) should be smaller than the thickness H of the first insulating layer 105.

Thereafter, as shown in FIG. 2B, the upper surface 105a of the first insulating layer 105 is ground to become a planar surface, for example, by a chemical mechanical grinding process. In order to ensure that the concave-convex structure on the upper surface 105a of the first insulating layer 105 is entirely removed, the grinding should be performed to the first insulating layer 105 by a depth greater than h and less than H. In addition, the remaining portion of the first insulating layer after being ground is configured to ensure that the first insulating layer 105 covers the entire reflective layer 104 in the concavo-convex shape. Note that the process of planarizing the upper surface of the first insulating layer 105 is not limited to the chemical mechanical grinding process. It is possible to employ other planarization processes, which are not limited herein.

Next, as shown in FIG. 2C, a transparent electrode layer of uniform thickness, e.g. an ITO layer, is deposited on the first insulating layer 105 having a upper surface 105a in a planar shape, and then the first electrode 106 in a comb-shape is formed with a patterning process. Since the first electrode 106 is formed on the planar upper surface 105a of the first insulating layer 105, the first electrode 106 extends on the planar upper surface of the first insulating layer 105. Therefore, the first electrode 106 as well as the second electrode below 103 it cooperate to form a substantially normal electric field, which prevents electric field distortion.

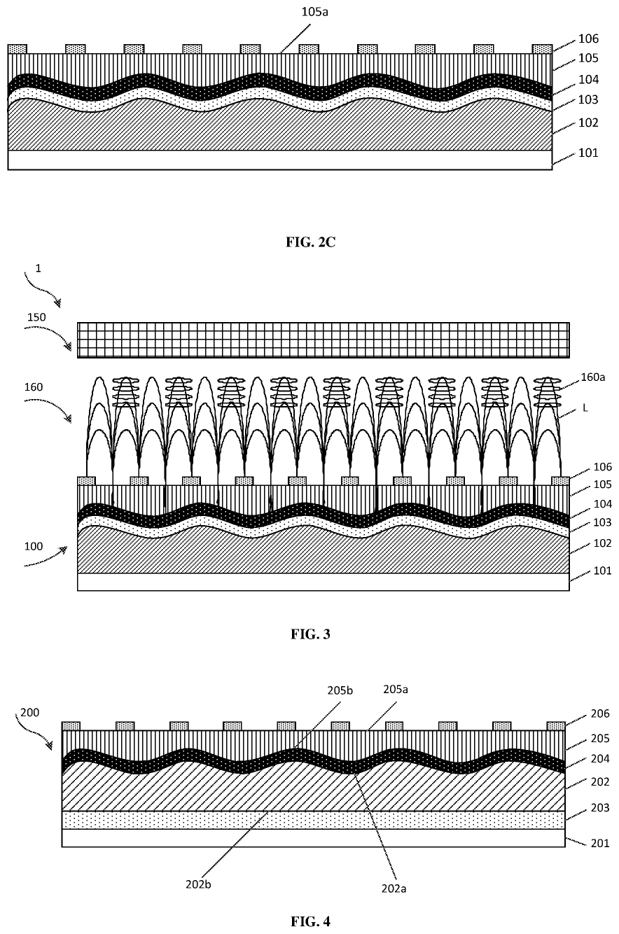

FIG. 3 shows a structural schematic view of the liquid crystal display panel of the reflective type 1 including the array substrate 100 shown in FIG. 1. As shown in FIG. 3, the liquid crystal display panel of the reflective type 1 includes the array substrate 100 as shown in FIG. 1 and a color filter substrate 150 disposed opposite to the array substrate 100, and a liquid crystal layer between the array substrate 100 and the color filter substrate 150. The liquid crystal layer 160 contains a plurality of liquid crystal molecules 160a therein. A distribution of electric power lines L in the electric field formed between the first electrode 106 and the second electrode 103 is shown in FIG. 3. As shown in FIG. 3, a substantially normal electric field is formed between the first electrode 106 and the second electrode 103, and the liquid crystal molecules 160a above the array substrate 100 are normally deflected in a horizontal electric field, and the long axes of the liquid crystal molecules are arranged in a direction parallel to the array substrate 100 and the color filter substrate 150, so that the display panel 1 may normally display pictures. Moreover, since the reflective layer 104 is in a concavo-convex shape, light reflectance may be increased, thereby increasing the display brightness of the display panel.

In comparison, FIG. 7 shows a structural schematic view of a liquid crystal display panel of the reflective type 10 as an alternative example. The liquid crystal display panel 10 shown in FIG. 7 has a structure similar to that of the liquid crystal display panel shown in FIG. 3, except that the upper surface of the first insulating layer 105′ is in a concavo-convex shape conforming to the concavo-convex shape of the reflective layer 104. In this case, the comb-shaped first electrode 106′ is distributed on the upper surface 105a′ of the first insulating layer 105′ in the concavo-convex shape, and parts of the first electrode 106′ at different locations thereof forms different inclined angles with respect to the base substrate 101, thereby the electric fields generated by the first electrodes 106 and the second electrode 103 are mutually interfered, so that the liquid crystal molecules 160a may not be deflected normally, thereby reducing the transmittance of the light, resulting in uneven distribution of brightness of the display panel. In other words, although the concave-convex surface of the reflective layer 104 may increase the reflectance of the light, it reduces the light transmittance and thus may not increase the brightness of the display panel.

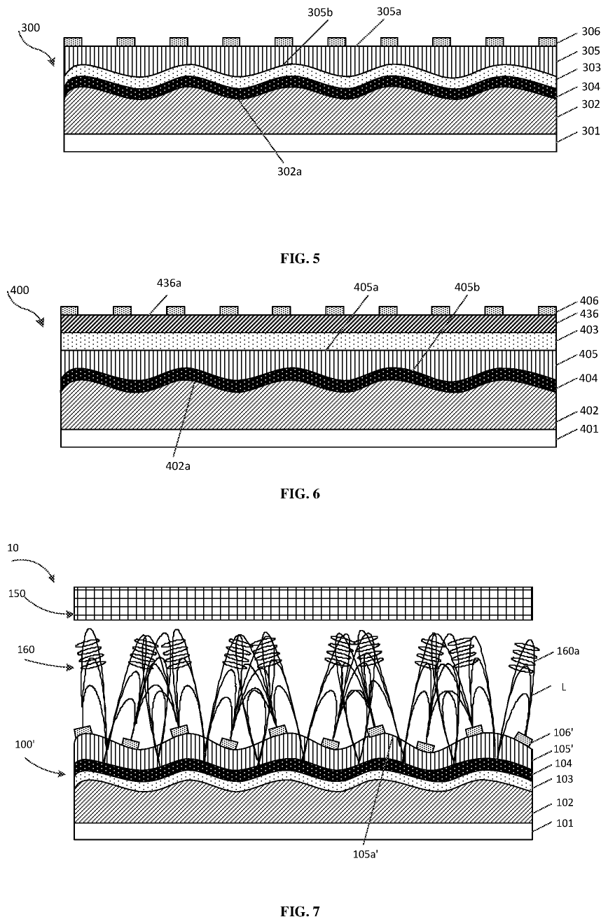

FIG. 4 shows a structural schematic view of an array substrate of a liquid crystal display panel of the reflective type 200 according to another exemplary embodiment of the present disclosure. As shown in FIG. 4, the array substrate 200 includes, in an order from bottom to top in FIG. 4, a base substrate 201, a second electrode 203, a second insulating layer 202, a reflective layer 204, a first insulating layer 205, and the first electrodes 206.

In the embodiment shown in FIG. 4, a second insulating layer 202 is disposed between the second electrode 203 and the reflective layer 204. The second electrode 203 is disposed on a side of the second insulating layer 202 away from the reflective layer 203. The second electrode 203 deposited on the planar base substrate 201 is a plate electrode and has a uniform thickness. Further, the second electrode 203 extends in a plane parallel to the base substrate 201 of the array substrate 200, and is in a planar shape. The second insulating layer 202 is formed on the second electrode 203 in a flat shape, a lower surface 202b of which is a planar surface, and an upper surface 202a of which is in a concavo-convex shape. The reflective layer 204 is formed on the second insulating layer 202 having an upper surface of a concavo-convex shape and has a uniform thickness. Therefore, the reflective layer 204 is also in a concavo-convex shape conforming to the concavo-convex shape of the upper surface 202a of the second insulating layer 202. The first insulating layer 205 is disposed above the reflective layer 204. A lower surface 205b of the first insulating layer 205 is in a concavo-convex shape that conforms to the concavo-convex shape of the reflective layer 204. An upper surface 205a of the first insulating layer 205 is formed as a planar surface. The first electrode 206 is a comb electrode and is formed on the planar upper surface 205a of the first insulating layer 205, so that the first electrode 206 extends on the planar upper surface of the first insulating layer 205, that is, extends in a plane parallel to the base substrate 201 of the array substrate 200.

The method of manufacturing the array substrate 200 of this embodiment is similar to the embodiment shown in FIG. 1, except that the second electrode 203 extends on the planar surface of the first insulating layer 205 of the array substrate 200 and is parallel to the first electrode 206. A second insulating layer 202 is formed between the second electrode 203 and the reflective layer 204. The lower surface of the second insulating layer 202 is a planar surface, and the upper surface thereof is in a concavo-convex shape. The reflective layer 204 is formed on the upper surface of the second insulating layer 202 in the concavo-convex shape to have a concave-convex shape. Other aspects of this embodiment are the same as those of the embodiment shown in FIG. 1, and details are not described herein again.

According to this embodiment, both the first electrode 206 and the second electrode 203 extend in a plane parallel to the planar upper surface of the first insulating layer 205, and the first electrode 206 and the second electrode 203 are parallel to each other, thereby prevent the electric field between the first electrode 206 and the second electrode 203 from being distorted. A normal electric field can be formed between the first electrode 206 and the second electrode 203. Therefore, the liquid crystal molecules contained in the liquid crystal display panel having the array substrate 200 can be normally deflected, and the quality of the picture displayed by the display panel is improved.

FIG. 5 shows a structural schematic view of an array substrate 300 of a liquid crystal display panel of the reflective type according to another exemplary embodiment of the present disclosure. As shown in FIG. 5, the array substrate 300 includes, in an order from bottom to top in FIG. 5, a base substrate 301, a second insulating layer 302, a reflective layer 304, a second electrode 303, a first insulating layer 305, and the first electrode 306. This embodiment differs from the embodiment shown in FIG. 1 in that, in the embodiment shown in FIG. 1, the reflective layer 104 is located above the second electrode 103; and in the embodiment shown in FIG. 5, the reflection layer 304 is located below the second electrode 303, and the second electrode 303 is disposed between the reflective layer 304 and the first insulating layer 305. In this case, the second electrode 303 should be a transparent electrode, for example, made of a transparent conductive material such as ITO.

Specifically, in the array substrate 300 shown in FIG. 5, the base substrate 301 may be, for example, a flat glass substrate on which a TFT element film layer may be formed for supplying a driving voltage to the first electrode 306 or the second electrode 303. The second insulating layer 302 is disposed on the base substrate 301, and an upper surface 302a of the second insulating layer 302 is in a concavo-convex shape. The reflective layer 304 above the second insulating layer 302 has a uniform thickness, and therefore, the reflective layer 304 is in a concavo-convex shape that conforms to the concavo-convex shape of the upper surface 302a of the second insulating layer 302. The second electrode 303 is formed on the reflective layer 304 having a concavo-convex shape and has a uniform thickness. Therefore, the second electrode 303 is also in a concavo-convex shape conforming to the concavo-convex shape of the upper surface of the second insulating layer 302. The first insulating layer 305 is disposed above the second electrode 303. A lower surface 305b of the first insulating layer 305 is in a concavo-convex shape that conforms to the concavo-convex shape of the second electrode 303. An upper surface 305a of the first insulating layer 305 is formed as a planar surface. The first electrode 306 is a comb electrode and is formed on the planar upper surface 305a of the first insulating layer 305 such that the first electrode 306 extends in a plane substantially parallel to the base substrate 301 of the array substrate 300.

The method of manufacturing the array substrate of this embodiment is substantially the same as the method of manufacturing the array substrate of the embodiment shown in FIG. 1, except that the order of forming the reflective layer and the second electrode is reversed, and the second electrode is disposed on a side of the reflective layer away from the second insulating layer. and is a transparent electrode. Specifically, the second electrode is disposed between the reflective layer and the first insulating layer. Other aspects of this embodiment are the same as those of the embodiment shown in FIG. 1, and details are not described herein again.

According to this embodiment, the comb-shaped first electrode 306 is formed on the planar upper surface of the first insulating layer 305, and extends on the planar upper surface of the first insulating layer 305. Therefore, a substantially normal electric field is formed between the first electrode 306 and the second electrode 303. When being used in a liquid crystal display panel, liquid crystal molecules above the array substrate 300 are normally deflected in a horizontal electric field, and the display panel may normally display a picture.

The embodiments of FIGS. 1 and 5 show that, in the array substrate, the reflective layer and the second electrode are formed separately and are located in different layers. However, as a variation of the embodiments shown in FIGS. 1 and 5, the reflective layer and the second electrode in FIGS. 1 and 5 may also be formed in a unitary structure, that is, the second electrode itself functions as a reflective layer. In this way, the fabrication process of the array substrate can be simplified and the processes may be saved.

FIG. 6 shows a structural schematic view of an array substrate of a liquid crystal display panel of the reflective type 400 according to another exemplary embodiment of the present disclosure. As shown in FIG. 6, the array substrate 400 includes, in an order from bottom to top in FIG. 6, a base substrate 401, a second insulating layer 402, a reflective layer 404, a first insulating layer 405, and a second electrode 403, a third insulating layer 436 and a first electrode 406.

In the embodiment shown in FIG. 6, the second insulating layer 402 is disposed on the planar base substrate 401, and an upper surface 402a thereof is formed in a concavo-convex shape. The reflective layer 404 on the second insulating layer 402 has a uniform thickness. Therefore, the reflective layer 404 is also in a concavo-convex shape that conforms to the concavo-convex shape of an upper surface 402a of the second insulating layer 402. The first insulating layer 405 is disposed above the reflective layer 404. A lower surface 405b of the first insulating layer 405 is in a concavo-convex shape that conforms to the concavo-convex shape of the reflective layer 404. An upper surface 405a of the first insulating layer 405 is formed as a planar surface. The second electrode 403 is deposited on the planar upper surface 405a of the first insulating layer 405 and has a uniform thickness. Therefore, the second electrode 403 extends in a plane parallel to the planar upper surface of the first insulating layer 405. The third insulating layer 436 is formed on the second electrode 403 and has a uniform thickness, and the upper and lower surfaces thereof are both planar surfaces. The first electrode 406 is a comb electrode and is formed on the planar upper surface 436a of the third insulating layer 436. Further, the first electrode 406 also extends on the upper surface of the first insulating layer 405 in a planar shape and is parallel to the second electrode 403. Other aspects of the array substrate of this embodiment are the same as those of the embodiment shown in FIG. 5, and details are not described herein again.

The method of manufacturing the array substrate of the embodiment is similar to the embodiment shown in FIG. 5, except that the second electrode 403 is disposed on the planar upper surface 405a of the first insulating layer 405, and is spaced apart from the reflective layer 404. Specifically, the second electrode 403 is disposed between the first electrode 406 and the first insulating layer 405, and the third insulating layer 436 is disposed between the second electrode 403 and the first electrode 406, and the second electrode 403 extends in a plane parallel to the planar surface of the first insulating layer 405. The upper and lower surfaces of the third insulating layer 436 are both planar surfaces, and the first electrode 406 is disposed on the upper surface of the third insulating layer 436. Other aspects of this embodiment are the same as those of the embodiment shown in FIG. 5, and details are not described herein again.

According to this embodiment, the first electrode 406 and the second electrode 403 are both disposed above the first insulating layer 405, and the first insulating layer 405 is disposed above the reflective layer 404 and serves to flatten the concave-convex shape of the reflective layer. Both the first electrode 406 and the second electrode 403 extend in a plane parallel to the planar upper surface 405a of the first insulating layer 405, and the first electrode 406 and the second electrode 403 are parallel to each other. Thus, the electric field between the first electrode 406 and the second electrode 403 is further prevented from being distorted. Therefore, the liquid crystal molecules in the liquid crystal display panel including the array substrate 400 are normally deflected, and the display panel may display the screen normally.

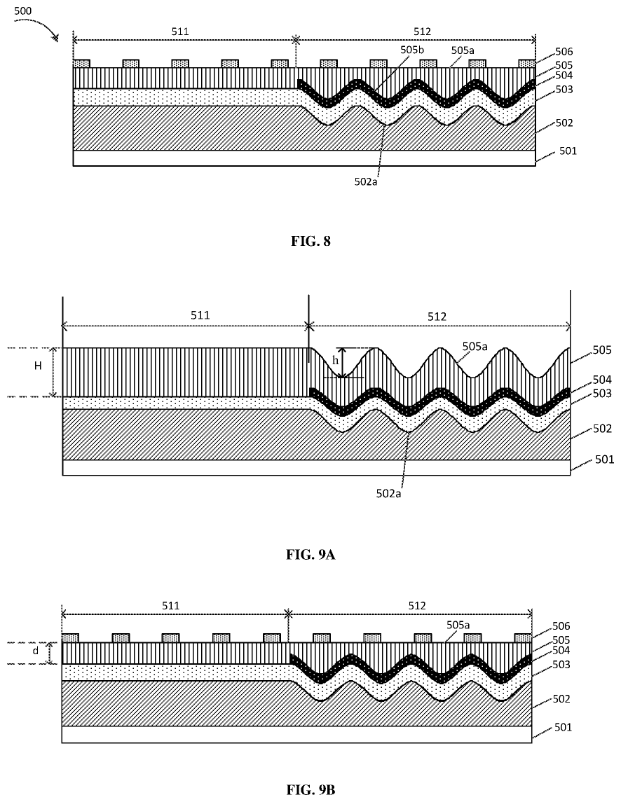

The above embodiments are all described by taking an array substrate of a liquid crystal display panel of the reflective type as an example. It should be understood that the concepts of the present disclosure may be applied to any liquid crystal display panel having a reflective region. FIG. 8 shows a schematic structural view of an array substrate of a liquid crystal display panel of the transflective type according to an exemplary embodiment of the present disclosure. FIG. 8 shows the structure of one pixel unit of the array substrate. As shown in FIG. 8, each pixel unit of an array substrate 500 includes a transmissive region 511 and a reflective region 512. In the transmissive region 511, the array substrate 500 includes, in an order from bottom to top in FIG. 8, a base substrate 501, a second insulating layer 502, a second electrode 503, a first insulating layer 505, and a first electrode 506. In the reflective region 512, the array substrate 500 includes, in an order from bottom to top in FIG. 8, a base substrate 501, a second insulating layer 502, a second electrode 503, a reflective layer 504, a first insulating layer 505, and a first electrode 506. There is no reflective layer in the transmissive region 511 so as to achieve the image display with light transmitted upward from a bottom side of the array substrate 500. A reflective layer 504 is provided in the reflective region 512 to reflect light emitted from a top side of the array substrate 500 to achieve the image display.

The base substrate 501 may be, for example, a flat glass substrate on which a TFT element film layer may be formed for supplying a driving voltage to the first electrode 506 or the second electrode 503. The second insulating layer 502 is disposed on the base substrate 501. In the transmissive region 511, an upper surface 502a of the second insulating layer 502 is in a flat shape. In the reflective region 512, the upper surface 502a of the second insulating layer 502 is in a concavo-convex shape. The second electrode 503 deposited on the upper surface 502a of the second insulating layer 502 is a plate electrode and has a uniform thickness, and therefore, the second electrode 503 is in a flat shape in the transmissive region 511 and is in a concavo-convex shape in the reflective region 512. The reflective layer 504 is formed on the second electrode 503 in the reflective region 512 and has a uniform thickness, and therefore, the reflective layer 504 is in a concavo-convex shape. The first insulating layer 505 is formed on the second electrode 503 in the transmissive region 511 and formed on the reflective layer 504 in the reflective region 512. In the transmissive region 511, upper and lower surfaces of the first insulating layer 505 are both in a flat shape. In the reflective region 512, the lower surface 505b of the first insulating layer 505 is in a concavo-convex shape, and the upper surface 505a is in a flat shape. The first electrode 506 is a comb electrode and is formed on the planar upper surface 505a of the first insulating layer 505, so that the first electrode 506 extends on the plane of the base substrate 501 of the array substrate 500.

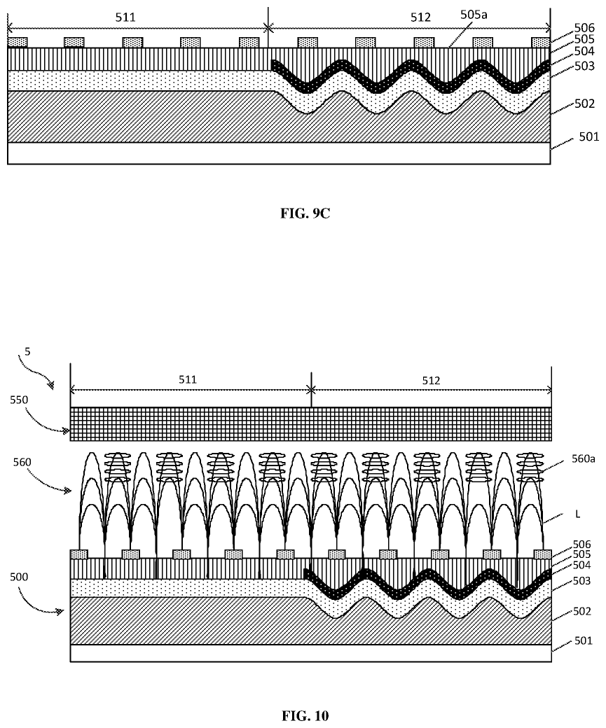

FIGS. 9A-9C show schematic views of a manufacturing process of the array substrate 500 shown in FIG. 8. As shown in FIG. 9A, firstly, a base substrate 501 is provided, which may include a TFT film layer; an insulating layer (i.e. the second insulating layer) 502, e.g. a photoresist layer, is laid on the base substrate 501, and the upper surface 502a of the second insulating layer 502 in the reflective region 512 is formed into a concavo-convex shape by, for example, a molding process. Next, a second electrode layer is deposited on the second insulating layer 502 by, for example, a sputtering process, and patterned to form the second electrode 503. The material of the second electrode may be a metal or an alloy. Next, in the reflective region 512, a reflective layer 504 is deposited on the second electrode 503 by, for example, a sputtering process. The material of the reflective layer 504 may be a metal such as silver that has a function to reflect light. Next, a transparent insulating layer (i.e. the first insulating layer) 505 is deposited on the reflective layer 504, for example, by a chemical vapor phase process. The first insulating layer is made of a transparent material. The second electrode 503, the reflective layer 504, and the first insulating layer 505 are deposited respectively, each having a uniform thickness, so as to have a shape conforming to the shape of the upper surface of the underlying second insulating layer 502. That is, in the transmissive region 511, the second electrode 503 and the first insulating layer 505 are in a flat shape; in the reflective region 512, the second electrode 503, the reflective layer 504, and the first insulating layer 505 are in a concavo-convex shape. The height h of the concavo-convex shape of the upper surface of the first insulating layer 505 (the vertical height between the highest point and the lowest point of the concave-convex surface) should be smaller than the thickness H of the first insulating layer 505.

Thereafter, as shown in FIG. 9B, the upper surface 505a of the first insulating layer 505 is ground to a planar surface, for example, by a chemical mechanical grinding process. In order to ensure that the concavo-convex structure on the upper surface 505a of the first insulating layer 505 is entirely removed, the first insulating layer 505 is ground by a height greater than h and less than H. In addition, the remaining portion of the first insulating layer after being ground is configured to ensure that the first insulating layer 505 covers the entire reflective layer 504 in the concavo-convex shape.

Next, as shown in FIG. 9C, a transparent electrode layer of a uniform thickness, e.g. an ITO layer, is deposited on the first insulating layer 505 having the planar upper surface 505a, and a comb-shaped first electrode 506 is formed with a patterning process. Since the first electrode 506 is formed on the planar upper surface 505a of the first insulating layer 505, that is, the first electrode 506 extends on the planar upper surface of the first insulating layer 505, that is, extends in a plane parallel to the base substrate 501. Therefore, in the transmissive region 511 and the reflective region 512, the first electrode 506 and the second electrode 503 therebelow may form a substantially normal electric field, preventing electric field distortion.

FIG. 10 shows a schematic structural view of a liquid crystal display panel 5 of the transflective type including the array substrate 500 shown in FIG. 8. As shown in FIG. 10, the transflective liquid crystal display panel 5 includes an array substrate 500 as shown in FIG. 8 and a color filter substrate 550 disposed opposite to the array substrate 500, and a liquid crystal layer 560 between the array substrate 500 and the color filter substrate 550. The liquid crystal layer 560 contains a plurality of liquid crystal molecules 560a. The distribution of the electric power lines L in the electric field formed between the first electrode 506 and the second electrode 503 is shown in FIG. 10. As shown in FIG. 10, a substantially normal electric field is formed between the first electrode 506 and the second electrode 503, and the liquid crystal molecules 560a above the array substrate 500 are normally deflected in the electric field, and the long axes of the liquid crystal molecules are arranged in a direction parallel to the array substrate 500 and the color filter substrate 550, so that the display panel 5 may display pictures normally. Moreover, since the reflective layer 504 is in a concavo-convex shape, the light reflectance can be increased, thereby increasing the display brightness of the display.

As a variation of the embodiment of the array substrate for the transflective liquid crystal display panel shown in FIG. 8, in the array substrate shown in FIG. 8, the positions of the second electrode 503 and the reflective layer 504 may be interchanged. When the second electrode is formed on the reflective layer, the second electrode is a transparent electrode. In this case, similar to the case shown in FIG. 6, an additional insulating layer may be disposed as a planarized layer between the second electrode and the reflective layer, such that the second electrode also has a flat shape which is parallel to the base substrate of the array substrate. In this case, the first electrode and the second electrode are both parallel to the base substrate with a normal electric field being formed therebetween, and the display panel can normally display the picture.

Although the various embodiments of the present disclosure have been described above with reference to the drawings, it is obvious that the described embodiments are some of the embodiments of the present disclosure, and not all of the embodiments. The general inventive idea of the present disclosure relates to an array substrate, comprising a plurality of pixel units, at least some of which respectively having a reflective region provided with a reflective layer in a concave-convex shape, wherein a first insulating layer is disposed on a light reflecting side of the reflective layer, and a surface of the first insulating layer adjacent to the reflective layer is in a concave-convex shape conforming to the concave-convex shape of the reflective layer, and a surface of the first insulating layer away from the reflective layer is a planar surface; the at least some of the pixel units further respectively comprise a first electrode and a second electrode which are oppositely disposed in different layers and are spaced apart from each other, and the first electrode is disposed on a side of the first insulating layer away from the reflective layer.

Accordingly, an embodiment of another aspect of the present disclosure relates to a method of manufacturing an array substrate, the array substrate comprising a plurality of pixel units, at least some of which respectively having a reflective region, the method comprising at least: forming a reflective layer in a concave-convex shape in the reflective region; forming a first insulating layer on a light reflecting side of the reflective layer; performing a planarization process a surface of the first insulating layer away from the reflective layer to form a planar surface; and forming a first electrode on a side of the first insulating layer away from the reflective layer, the first electrode extending on the planar surface of the first insulating layer.

Embodiments of another aspect of the present disclosure also relates to a display device including the array substrate of each of the above embodiments. Examples of the display device may include a device having a display function, such as a mobile phone, a tablet, a notebook computer, a digital photo frame, a personal digital assistant, a navigator, a television, which is not limited in the present disclosure. In the case where the display panel is a liquid crystal display panel of the transflective type, the display device may further include a backlight device disposed on a side of the array substrate opposite to the color filter substrate to provide a backlight source in the transmissive display.

According to an array substrate and a method of manufacturing the same, a liquid crystal display panel, and a display device according to an embodiment of the present disclosure, a first insulating layer is provided on the reflective layer in the concave-convex shape in the array substrate. The first insulating layer has a planar upper surface. The first electrode formed above the planar upper surface of the first insulating layer extends in a plane parallel to the planar surface of the first insulating layer, thereby forming a substantially normal electric field between the first electrode and the second electrode, preventing distortion of the electric field between the first electrode and the second electrode which would have caused a poor display effect of the display device. According to the display device of the present disclosure, it is possible to eliminate the adverse effect of the electric field distortion on the displayed picture and improve the quality of the display screen.

Although various embodiments of the present disclosure have been described above with reference to the drawings, those skilled in the art will understand that different embodiments may be combined or partially substituted without causing a conflict. Various modifications and variation may be made to the embodiments of the present disclosure without departing from the scope of the invention. All such modifications and variations are intended to fall within the scope of the present disclosure. Therefore, the protection scope of the present disclosure should be determined by those defined by the claims.

1. An array substrate, comprising a plurality of pixel units, at least some of which respectively having a reflective region provided with a reflective layer in a concave-convex shape, wherein
a first insulating layer is disposed on a light reflecting side of the reflective layer, and a surface of the first insulating layer adjacent to the reflective layer is in a concave-convex shape conforming to the concave-convex shape of the reflective layer, and a surface of the first insulating layer away from the reflective layer is a planar surface;
the at least some of the pixel units further respectively comprise a first electrode and a second electrode which are oppositely disposed in different layers and are spaced apart from each other, and the first electrode is disposed on a side of the first insulating layer away from the reflective layer.

2. The array substrate of claim 1, wherein the first electrode is a comb electrode and the second electrode is a plate electrode.

3. The array substrate of claim 2, further comprising a second insulating layer disposed on a side of the reflective layer away from the first insulating layer, the surface of the second insulating layer adjacent to the reflective layer is in a concave-convex shape conforming to the concave-convex shape of the reflective layer.

4. The array substrate of claim 3, wherein the second electrode is disposed on a side of the reflective layer away from the first insulating layer.

5. The array substrate of claim 4, wherein the second electrode is disposed between the reflective layer and the second insulating layer, and the second electrode is in a concave-convex shape conforming to the concave-convex shape of the reflective layer.

6. The array substrate of claim 4, wherein
the second electrode is disposed on a side of the second insulating layer away from the reflective layer.

7. The array substrate of claim 3, wherein the second electrode is disposed on a side of the reflective layer away from the second insulating layer and is a transparent electrode.

8. The array substrate of claim 7, wherein the second electrode is disposed between the reflective layer and the first insulating layer, and the second electrode is in a concave-convex shape conforming to the concave-convex shape of the reflective layer.

9. The array substrate of claim 7, wherein
the second electrode is disposed between the first electrode and the first insulating layer,
a third insulating layer is disposed between the second electrode and the first electrode, and
the second electrode extends in a plane parallel to a planar surface of the first insulating layer.

10. The array substrate of claim 4, wherein the second electrode is formed integrally with the reflective layer.

11. The array substrate of claim 1, wherein one of the first electrode and the second electrode is a pixel electrode, and the other of the first electrode and the second electrode is a common electrode.

12. The array substrate of claim 1, wherein the at least some of the pixel units further respectively comprise a transmissive region, the transmissive region not including the reflective layer.

13. The array substrate of claim 1, wherein each of the pixel units comprises a reflective region.

14. A method of manufacturing an array substrate, the array substrate comprising a plurality of pixel units, at least some of which respectively having a reflective region, the method comprising at least:
forming a reflective layer in a concave-convex shape in the reflective region;
forming a first insulating layer on a light reflecting side of the reflective layer;
performing a planarization process a surface of the first insulating layer away from the reflective layer to form a planar surface; and
forming a first electrode on a side of the first insulating layer away from the reflective layer, the first electrode extending on the planar surface of the first insulating layer.

15. The method of claim 14, further comprising:
forming a second insulating layer before forming the reflective layer;
patterning the second insulating layer such that a surface of the second insulating layer adjacent to a subsequently formed reflective layer is in a concave-convex shape;
forming the reflective layer on a side of the second insulating layer in a concave-convex shape such that the reflective layer is also in a concave-convex shape.

16. The method of claim 14, wherein the planarization process is chemical mechanical grinding.

17. The method of claim 15, further comprising disposing the second electrode on a side of the reflective layer away from the first insulating layer, or configuring the second electrode as a transparent electrode and disposing the second electrode on a side of the reflective layer away from the second insulating layer.

18. A display panel comprising:
the array substrate of claim 1.

19. A display device comprising the display panel of claim 18.

20. The method of claim 14, wherein a depth of the planarization process to the surface of the first insulating layer away from the reflective layer is less than a thickness of the first insulating layer.
